(19) United States
(12) Patent Application Publication
(10) Pub. No.: US 2012/0323969 A1
(43) Pub. Date: Dec. 20, 2012

(54) SEARCH FORMULA UPDATE DEVICE, SEARCH FORMULA UPDATE METHOD

(75) Inventors: Keiichi Iguchi, Tokyo (JP); Kazuya Koyama, Tokyo (JP)

(73) Assignee: NEC CORPORATION, Tokyo (JP)

(21) Appl. No.: 13/582,253

(22) PCT Filed: Feb. 24, 2011
(86) PCT No.: PCT/JP2011/054826

§ 371 Date: Aug. 31, 2012

(30) Foreign Application Priority Data
Mar. 1, 2010 (JP) 2010-043957

(51) Int. Cl. G06F 17/30

(52) U.S. Cl. 707/792; 707/E17.005

(57) ABSTRACT

Disclosed is a search formula update device capable of updating with high precision a search formula specifying an element of a structured document according to modifications of structure and content. The search formula update device is provided with a partial structure extraction unit for extracting a partial structure from structure information; a partial structure detection unit for detecting, among the extracted partial structures, partial structures constituting the structure of the post-update structured document; a structure reconstitution unit for combining the detected partial structures to reconstitute structure information of the post-update structured document; an objective element estimation unit for estimating an objective element in the post-update structured document on the basis of the detected partial structures and a search formula; and a search formula update unit for using the reconstituted structure information so as to specify the objective element in the post-update structured document to generate a search formula.

### TECHNICAL FIELD

The present invention relates to a search formula update device and a search formula update method for updating a search formula specifying an element of a structured document.

### BACKGROUND ART

In recent years, a structured document in which the content of a document is structuralized and the content of the document is stored along with information representing its structure is known. For example, the structure of the structured document is described by a markup language. As a typical markup language for describing the structure of the structured document, XML language (Extensible Markup Language) and HTML language (Hyper Text Markup Language) and the like are widely used.

An information processing device which processes such structured document acquires the content of an element to be an object based on the structure of the structured document and processes the content of the element. For example, a structured document retrieval device disclosed in patent document 1 performs processing of a full-text search about the content included in an element that is specified among elements of the structured document.

At the time when the content of an objective element is acquired from the structured document, such structured document retrieval device uses a search formula which specifies an element to be an object based on the structure of the structured document. As such search formula, Xpath (XML Path) Formula which specifies an element of an XML document is used, for example.

By using such search formula, an information processing device can acquire a content included in an objective element from various structured documents which have different contents or from structured documents whose contents are updated.

Meanwhile, when the structure of the structured document to be an object is changed, such information processing device may not be able to search for the objective element any more by a search formula which has been used before change. In order to handle such case, there is known an information processing device having a search formula update device which updates the search formula according to the change in the structure.

Patent document 2 discloses a technology of such search formula update device. An XPath update system described in patent document 2 analyzes a structured document before and after a change and converts it into structural data, calculates a difference between the structural data of before and after the change, and updates a search formula using the calculated difference. By tracking an element which has been moved in the change of the structure of the structured document, this XPath update system calculates the difference between structural data of before and after the change.

Patent document 3 discloses a technology of another such search formula update device. A half structural data difference management system described in patent document 3 creates structure overlapping data in which pieces of structural data of structured documents received in the past are overlapped, creates difference data between the structure overlap data and the structure data of a structured document received newly, and updates a search formula based on the difference data.

[Patent documents]

[Patent document 1] Japanese Patent Application Laid-Open No. 2000-200286

[Patent document 2] Japanese Patent Application Laid-Open No. 2004-46745

[Patent document 3] Japanese Patent Application Laid-Open No. 2009-37360

### SUMMARY OF THE INVENTION

### Problem To Be Solved By The Invention

In the above related art, there is a problem that the search formula specifying the element of the structured document may not be able to be updated with high accuracy according to the change in its structure and content.

That is, the technology disclosed in patent document 2 has a problem that, when the structure of the structured document is changed, if the content of the element does not stay the same, the search formula cannot be updated with high accuracy.

Specifically, because the XPath update system disclosed in patent document 2 calculates the difference so that a move of an element of an identical content may be tracked, it cannot calculate the difference when the element having the identical content does not exist. Accordingly, when the element of the identical content does not exist, the XPath update system cannot update the search formula. For example, when an objective element is moved and its content is changed, the XPath update system judges that the objective element has been eliminated. Accordingly, the XPath update system cannot update the search formula for specifying the objective element.

Also, the technology disclosed in patent document 3 has a problem that the search formula cannot update an objective element with high accuracy when relation between existing elements is changed greatly such as a case where a new element is added between the existing elements.

Specifically, a half structural data difference management system disclosed in patent document 3 compares each element of a new structured document with each element of structure overlap data, and extracts addition, change and deletion of the element to update the search formula. For this reason, when the new element is added between existing elements, for example, the half structural data difference management system judges that part of the existing elements has been eliminated. Accordingly, the half structural data difference management system cannot identify the objective element correctly in the structured document after change.

The present invention has been made in order to settle such problems, and its object is to provide a search formula update device which can update a search formula specifying an element of a structured document with higher accuracy according to a change in its structure and content.

### MEANS FOR SOLVING A PROBLEM

A search formula update device of the present invention includes: partial structure extraction unit which extracts part of partial structures from structure information on a structured document; partial structure detection unit which detects, among the partial structures, partial structures constituting a structure of a post-update structured document made by updating the structured document; structure reconstitution unit which reconstitutes structure information on the post-update structured document by connecting the partial structures detected by the partial structure detection unit; objective element estimation unit which estimates an objective element of the post-update structured document, the objective element corresponding to an objective element specified by a search formula in the structured document, based on the partial structures detected by the partial structure detection unit and the search formula; and search formula update unit which updates the search formula using the structure information reconstituted by the structure reconstitution unit such that the objective element estimated by the objective element estimation unit is specified in the post-update structured document.

In a search formula update method of the present invention, a search formula update device for updating a search formula for specifying an objective element of a structured document: extracts partial structures from structure information on a structured document; detects, among the extracted partial structures, partial structures constituting a structure of a post-update structured document made by updating the structured document; reconstituting structure information on the post-update structured document by connecting the detected partial structures; estimates an objective element of the post-update structured document, the objective element corresponding to an objective element of the structured document, based on the detected partial structures and the search formula; and updates the search formula, based on the reconstituted structure information and the estimated objective element, such that the objective element is specified in the post-update structured document.

A storage medium of the present invention stores a search formula update program for causing a computer to execute: processing of extracting part of partial structures from structure information on the structured document; processing of detecting, among the partial structures extracted by the processing of extracting partial structures, partial structures constituting a structure of a post-update structured document made by updating the structured document; processing of reconstituting structure information on the post-update structured document by connecting the partial structures detected by the processing of detecting partial structures constituting the structure; processing of estimating an objective element of the post-update structured document, the objective element corresponding to an objective element of the structured document, based on the detected partial structures and the search formula; and processing of updating the search formula, based on the reconstituted structure information and the objective element estimated by the processing of estimating an objective element, such that the objective element is specified in the post-update structured document.

### EFFECT OF THE INVENTION

The present invention can provide the search formula update device which can update the search formula for specifying the element of the structured document with higher accuracy according to the change in its structure and content.

### BRIEF DESCRIPTION OF THE DRAWINGS

FIG. 1 is a block diagram of a search formula update device as a first exemplary embodiment of the present invention.

FIG. 2 is a flow sheet illustrating an operation of the search formula update device as the first exemplary embodiment of the present invention.

FIG. 3 is a flow sheet illustrating an operation in which the search formula update device as the first exemplary embodiment of the present invention detects a partial structure.

FIG. 4 is a block diagram of a search formula update device as a second exemplary embodiment of the present invention.

FIG. 5 is a flow sheet illustrating an operation in which the search formula update device as the second exemplary embodiment of the present invention extracts a partial structure.

FIG. 6 is a flow sheet illustrating an operation in which the search formula update device as the second exemplary embodiment of the present invention reconstitutes a structure.

FIG. 7 is a flow sheet illustrating an operation in which the search formula update device as the second exemplary embodiment of the present invention estimates an objective element.

FIG. 8 is a block diagram of a search formula update device as a third exemplary embodiment of the present invention.

FIG. 9 is a diagram showing an example of a search formula with structure information in the third exemplary embodiment of the present invention.

FIG. 10 is a diagram showing an example of structure information in the third exemplary embodiment of the present invention.

FIG. 11 is a flow sheet illustrating an operation of the search formula update device as the third exemplary embodiment of the present invention.

FIG. 12 is a diagram showing an example of a partial structure extracted in the third exemplary embodiment of the present invention.

FIG. 13 is a diagram showing another example of a partial structure extracted in the third exemplary embodiment of the present invention.

FIG. 14 is a diagram showing another example of a partial structure extracted in the third exemplary embodiment of the present invention.

FIG. 15 is a diagram showing another example of a partial structure extracted in the third exemplary embodiment of the present invention.

FIG. 16 is a diagram showing another example of a partial structure extracted in the third exemplary embodiment of the present invention.

FIG. 17 is a diagram showing another example of a partial structure extracted in the third exemplary embodiment of the present invention.

FIG. 18 is a diagram showing another example of a partial structure extracted in the third exemplary embodiment of the present invention.

FIG. 19 is a diagram showing an example of a structured document after update in the third exemplary embodiment of the present invention.

FIG. 20 is a diagram showing an example of structure information reconstructed in the third exemplary embodiment of the present invention.

FIG. 21 is a diagram showing an example of a search formula updated in the third exemplary embodiment of the present invention.

FIG. 22 is a block diagram when composing the first and second exemplary embodiments of the present invention by a general-purpose computer.

FIG. 23 is a block diagram when composing the third exemplary embodiment of the present invention by a general-purpose computer.

FIG. 24 is a diagram showing an example of a recording medium in which a program of the present invention is recorded.

### Exemplary Embodiments For Carrying Out The Invention

[The first exemplary embodiment]

Next, the first exemplary embodiment of the present invention will be described in detail with reference to a drawing.

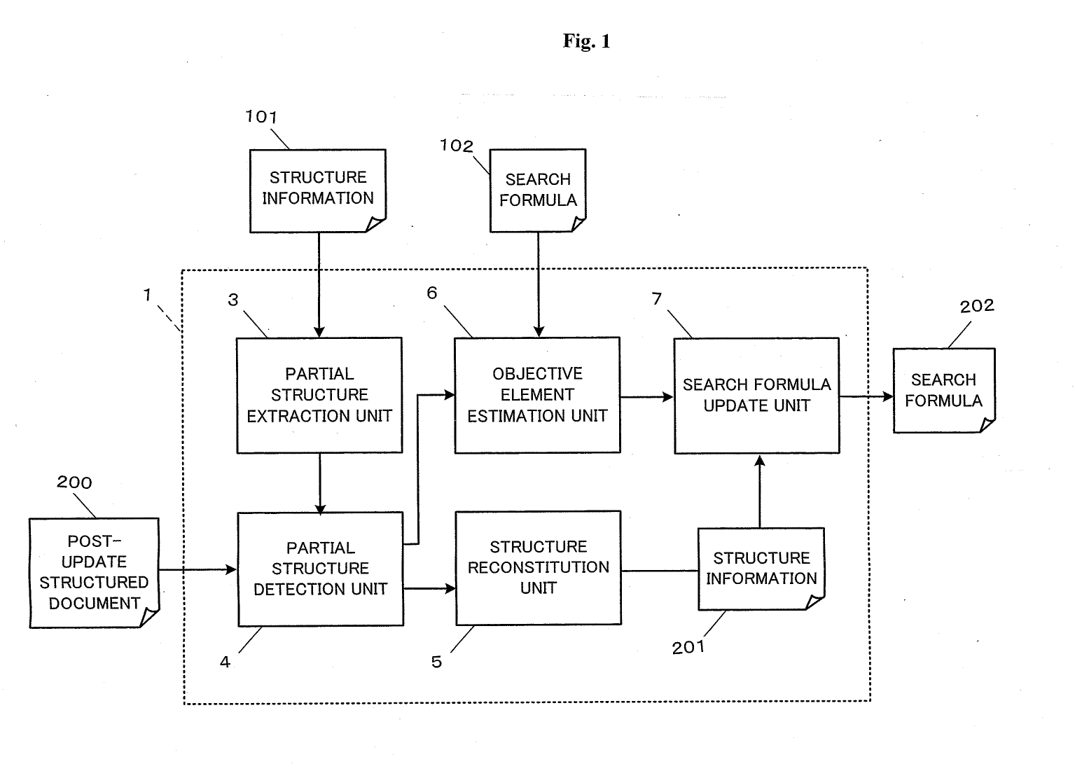

A structure of a search formula update device 1 as the first exemplary embodiment of the present invention is shown in FIG. 1.

In FIG. 1, the search formula update device 1 includes a partial structure extraction unit 3, a partial structure detection unit 4, a structure reconstitution unit 5, an objective element estimation unit 6 and a search formula update unit 7 as function blocks.

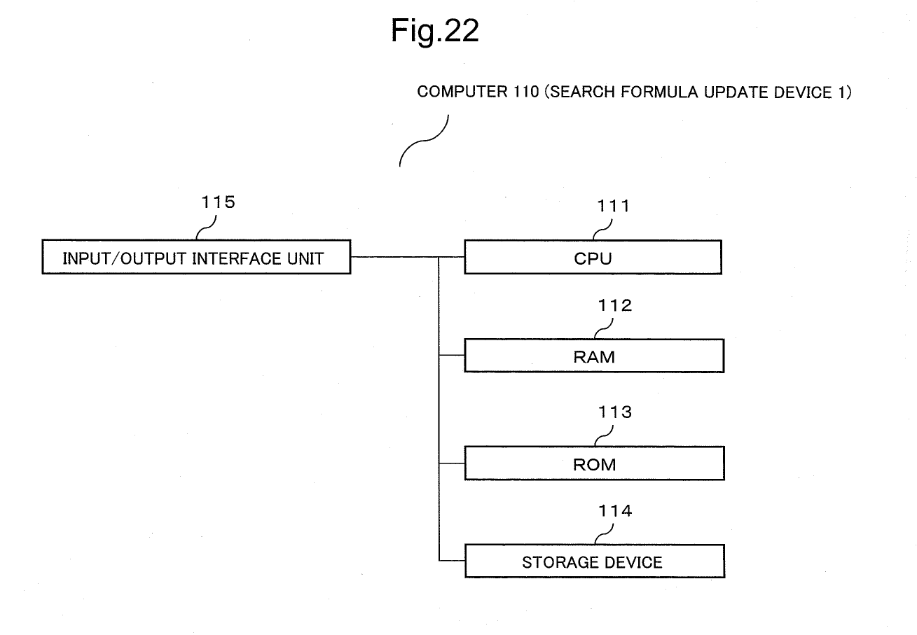

Here, the search formula update device 1 may be composed by a general-purpose computer 110 as shown in FIG. 22.

Referring to FIG. 22, the general-purpose computer 110 includes a CPU (Central Processing Unit) 111, a RAM (Random Access Memory) 112, a ROM (Read Only Memory) 113 and a storage device (a hard disk device which is also called a storage medium, for example) 114.

Further, the general-purpose computer 110 is equipped with an input/output interface unit 115.

In this case, the partial structure extraction unit 3, the partial structure detection unit 4, the structure reconstitution unit 5, the objective element estimation unit 6 and the search formula update unit 7 correspond to the CPU 111, the RAM 112, the ROM 113 and the storage device 114. Programs to be executed by the CPU 111 are stored in the storage device 114. Meanwhile, part of each of the above programs may be stored in the ROM 113.

The CPU 111 reads a program stored in the storage device 114 into the RAM 112, and carries out predetermined processing based on the program which has been read.

An input/output interface unit 115 performs transmission and reception of control information and data of a processing object between the search formula update device 1 and an external device based on directions of the CPU 111. The input/output interface unit 115 may be included in the partial structure extraction unit 3, the partial structure detection unit 4 and the objective element estimation unit 6.

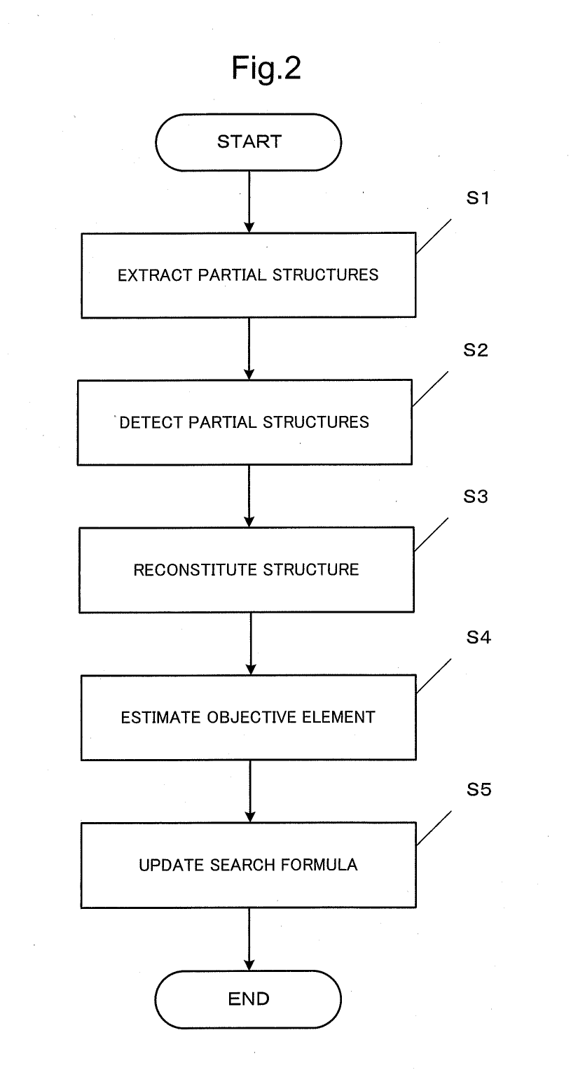

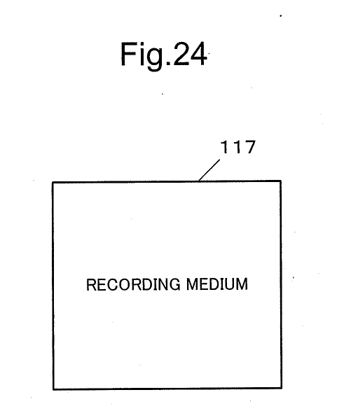

FIG. 24 is a diagram showing an example of a recording medium (storage medium) 117 in which a program is recorded (stored). The recording medium 117 is a non-volatile recording medium storing information non-temporarily. Meanwhile, the recording medium 117 may be a recording medium storing information temporarily. The recording medium 117 records a program (software) which causes the general-purpose computer 110 (the CPU 111) to carry out operations shown in FIGS. 2, 3, 5, 6, 7 and 11. Meanwhile, the recording medium 117 may further record optional programs and data.

The recording medium 117 recording the codes of the above-mentioned programs (software) may be supplied to the general-purpose computer 110, and the CPU 111 may read and carry out the codes of a program stored in the recording medium 117. Alternately, the CPU 111 may store the codes of a program stored in the recording medium 117 in the RAM 112. That is, this exemplary embodiment includes an exemplary embodiment of the recording medium 117 which stores a program executed by the general-purpose computer 110 (the CPU 111) temporary or non-temporarily. In FIG. 1, the partial structure extraction unit 3 acquires structure information 101 on a structured document from outside.

Then, the partial structure extraction unit 3 extracts parts which constitute the structure information 101 as a partial structure based on the acquired structure information 101.

The structure information 101 is structure information corresponding to a structured document before update.

Meanwhile, the structure information 101 may be stored in the storage device of the computer which forms the search formula update device 1 in advance. Also, the structure information 101 may be acquired by an application which operates on the computer which forms the search formula update device 1 via a network and inputted to the partial structure extraction unit 3.

The partial structure detection unit 4 acquires a post-update structured document 200 in which at least the structure of a structured document having the structure information 101 is updated from outside. Then, the partial structure detection unit 4 detects, among partial structures extracted by the partial structure extraction unit 3, ones of which the post-update structured document 200 is constituted.

Meanwhile, the post-update structured document 200 may be generated by an application which operates on the computer forming the search formula update device 1, and be inputted to the partial structure detection unit 4. Alternatively, the post-update structured document 200 may be acquired by an application which operates on the computer forming the search formula update device 1 via a network, and inputted to the partial structure detection unit 4.

The structure reconstitution unit 5 connects partial structures detected by the partial structure detection unit 4 from the post-update structured document 200 in a manner conforming to the structure of the post-update structured document 200 to reconstitute structure information 201 on the post-update structured document 200.

The structure information 201 is structure information corresponding to the post-update structured document 200.

Specifically, the structure reconstitution unit 5 connects, among partial structures detected from the post-update structured document 200 by the partial structure detection unit 4, partial structures including identical elements in turn so that identical elements may be matched.

The objective element estimation unit 6 acquires a search formula 102 from outside. Then, the objective element estimation unit 6 estimates an objective element of the post-update structured document 200 corresponding to the objective element having been specified by the search formula 102 in the structured document before update based on the partial structures detected by the partial structure detection unit 4 and the search formula 102.

The search formula 102 is a search formula corresponding to a structured document before update.

Meanwhile, the search formula 102 may be stored in the storage device of the computer forming the search formula update device 1 in advance. Alternatively, the search formula 102 may be acquired by an application which operates on the computer forming the search formula update device 1 via a network, and inputted to the objective element estimation unit 6.

The search formula update unit 7 updates the search formula 102 so that the objective element estimated by the objective element estimation unit 6 may be specified using the reconstituted structure information 201, and generates a search formula 202. At that time, the search formula update unit 7 generates the search formula 202 using elements included in the reconstituted structure information 201 as a condition.

The search formula 202 is a search formula corresponding to the post-update structured document 200.

Operations of the search formula update device 1 that is configured as above will be described using FIG. 2.

First, the partial structure extraction unit 3 extracts partial structures from the structure information 101 (Step S1). Next, the partial structure detection unit 4 detects, among the partial structures extracted in Step S1, partial structures constituting the post-update structured document 200 (Step S2). Details of operations by which the partial structure detection unit 4 detects a partial structure will be described later.

Next, the structure reconstitution unit 5 connects the partial structures detected in Step S2 and reconstitutes the structure information 201 of the post-update structured document 200 (Step S3).

Next, the objective element estimation unit 6 estimates an objective element in the post-update structured document 200 based on the partial structures detected in Step S2 and the search formula 102 (Step S4).

Next, the search formula update unit 7 generates the search formula 202 by updating the search formula 102 so that the objective element estimated in Step S4 may be specified using the structure information 201 reconstituted in Step S3 (Step S5).

By this, the search formula update device 1 finishes operating.

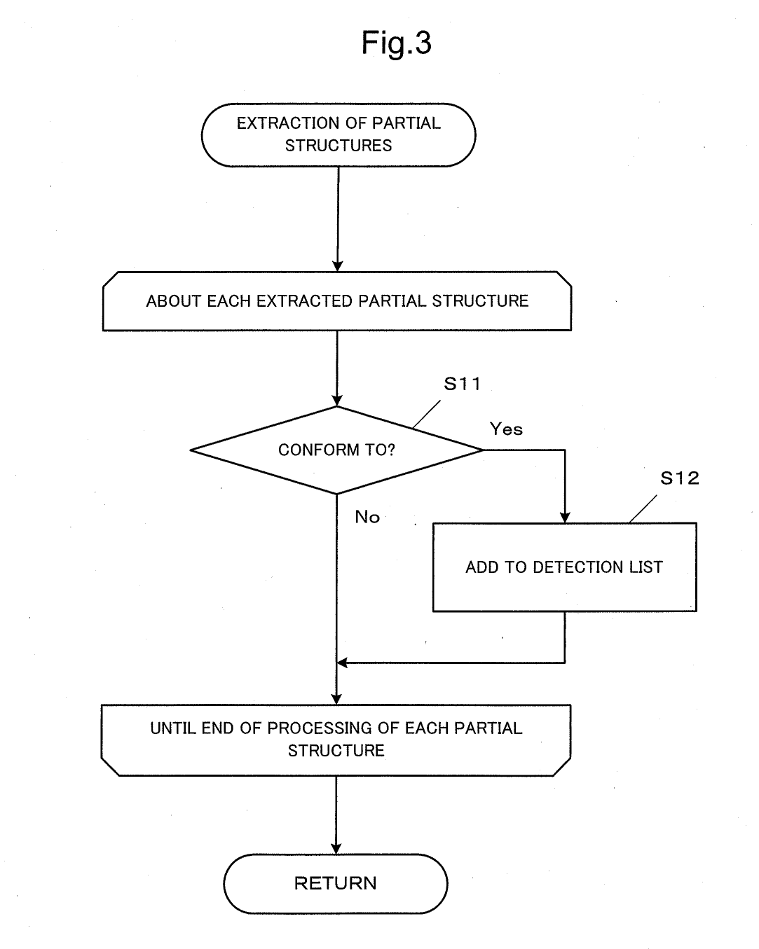

Next, operations in which the partial structure detection unit 4 detects a partial structure in Step S2 will be described using FIG. 3.

Here, first, about each of the partial structures extracted in Step S1, the partial structure detection unit 4 determines whether it conforms to the structure of the post-update structured document 200 (Step S11).

Here, when it is determined to be conforming, the partial structure detection unit 4 adds the conforming partial structure to a detection list (Step S12).

The partial structure detection unit 4 ends the detection operation when Steps S11-S12 have been performed for all partial structures, and the operation of the search formula update device 1 returns to Step S4 of FIG. 2.

Next, an effect of the first exemplary embodiment of the present invention will be described.

A search formula update device as the first exemplary embodiment of the present invention can update a search formula for specifying an element of a structured document with higher accuracy according to a change in its structure and content.

The reason of this is that, because partial structures extracted from structure information before update are connected and reconstituted so that they may conform to the structure of the structured document after update, it is possible to estimate an objective element in the structured document after update based on the reconstituted structure information.

Specifically, the reason is that the following structure is included. That is, first, the partial structure extraction unit 3 extracts part of partial structures from structure information of a structured document. Secondly, among the partial structures extracted by the partial structure extraction unit 3, the partial structure detection unit 4 detects ones which constitute the structure of a post-update structured document made by updating the structured document. Thirdly, the structure reconstitution unit 5 connects the partial structures detected by the partial structure detection unit 4 and reconstitutes structure information on the post-update structured document. Fourth, the objective element estimation unit 6 estimates an objective element of the post-update structured document corresponding to an objective element having been specified by a search formula in the structured document based on the partial structures detected by the partial structure detection unit 4 and the search formula. Fifth, using the structure information reconstituted by the structure reconstitution unit 5, the search formula update unit 7 updates the search formula so that it may specify in the post-update structured document the objective element estimated by the objective element estimation unit 6.

### The Second Exemplary Embodiment

Next, the second exemplary embodiment of the present invention will be described in detail with reference to a drawing.

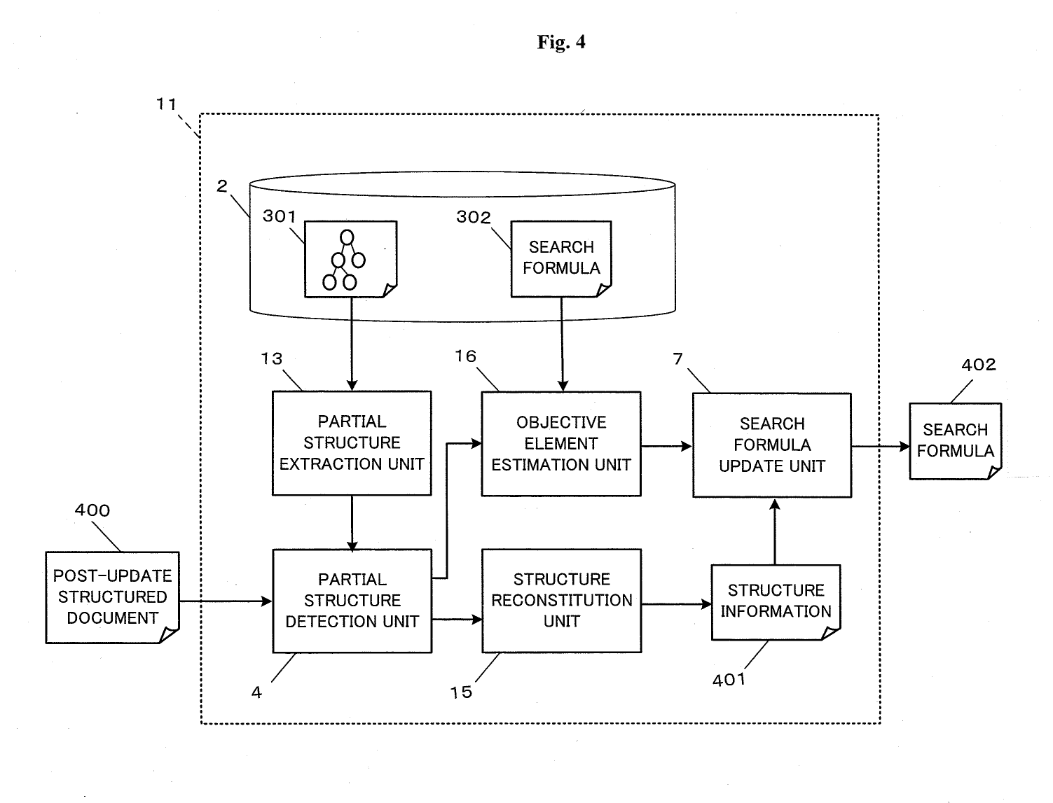

A structure of a search formula update device 11 as the second exemplary embodiment of the present invention is shown in FIG. 4. Meanwhile, in FIG. 4, to a structure identical with that of the search formula update device 1 as the first exemplary embodiment of the present invention, an identical code is given and detailed description will be omitted.

In FIG. 4, the search formula update device 11 is different from the search formula update device 1 as the first exemplary embodiment of the present invention in a point that it further includes a storage unit 2 which stores structure information 301 and a search formula 302. Also, the search formula update device 11 is different from the search formula update device 1 in a point that it includes a partial structure extraction unit 13 in place of the partial structure extraction unit 3. Further, the search formula update device 11 is different from the search formula update device 1 in a point that it includes a structure reconstitution unit 15 in place of the structure reconstitution unit 5. Yet further, the search formula update device 11 is different from the search formula update device 1 in a point that it includes an objective element estimation unit 16 in place of the objective element estimation unit 6.

The structure information 301 is structure information corresponding to a structured document before update.

The search formula 302 is a search formula corresponding to a structured document before update.

Here, as is the case with the search formula update device 1 as the first exemplary embodiment of the present invention, the search formula update device 11 may be formed by the general-purpose general-purpose computer 110 as shown in FIG. 22. In this case, the storage unit 2 may be formed by the storage device 114. The partial structure extraction unit 13, the structure reconstitution unit 15 and the objective element estimation unit 16 correspond to the CPU 111, the RAM 112, the ROM 113 and the storage device 114. Programs executed by the CPU 111 are stored in the storage device 114. Further, part of each of the above programs may be stored in the ROM 113.

The CPU 111 reads a program stored in the storage device 114 into the RAM 112, and carries out predetermined processing based on the program which has been read.

A network interface unit 135 performs transmission and reception of control information and data of a processing object between the search formula update device 11 and an external device based on directions of the CPU 111. The input/output interface unit 115 may be included in the partial structure detection unit 4.

In FIG. 4, the structure information 301 stored in the storage unit 2 is expressed by a tree structure. For example, when a structured document is an XML document, the structure information 301 is described by a schema language such as a DTD (Document Type Definition) and XML Schema which can describe a tree structure.

The search formula 302 stored in the storage unit 2 specifies a position of an element in a structure configured by a tree structure. For example, when a structured document is an XML document, the search formula 302 is described by a query language such as Xpath Formula. Xpath includes a route element described by a slash ‘/’. For example, a child element of a route element is described as ‘/a’.

The partial structure extraction unit 13 extracts from the structure information 301 as a partial structure: a shortest path of each of elements constituting the structure information 301 from a route element; a shortest path from an objective element specified by the search formula 302 to each element in a tree structure; each end element in a tree structure; a route from each element to an element which is connected to the original element by the number of steps set in advance; or, among each of the elements, each element of a kind set in advance, respectively. Meanwhile, the partial structure extraction unit 13 does not need to extract all of these partial structures. The partial structure extraction unit 13 may extract partial structures of one of kinds set in advance, or a combination of partial structures of kinds set in advance.

The partial structure detection unit 4 acquires a post-update structured document 400 that has been made by updating at least the structure of a structured document having the structure information 301. The partial structure detection unit 4 detects, among partial structures extracted from the structure information 301 by the partial structure extraction unit 13, partial structures constituting the structure of the post-update structured document 400.

The structure reconstitution unit 15 connects, among the detected partial structures, those partial structures including identical elements in the post-update structured document 400 successively so that the identical elements may be matched, and reconstitutes structure information 401.

The structure information 401 is structure information corresponding to the post-update structured document 400.

The structure reconstitution unit 15 pursues, about a partial structure not connected to any of partial structures which are connected so that a route element may be included in the post-update structured document 400, a parent element until an element which is included in any of the partial structures which are connected so that the route element may be included, or a route element is reached. After that, the structure reconstitution unit 15 connects the partial structure, which is not being connected, to the element having been reached in a manner including the traced route.

Meanwhile, the structure reconstitution unit 15 may make the storage unit 2 store the structure information 401 reconstituted.

The objective element estimation unit 16 detects, among the detected partial structures, an element with which an objective element of a partial structure which has included an objective element having been specified by the search formula 302 in the structure information 301 is identical in the post-update structured document 400. Then, the objective element estimation unit 16 estimates the detected element as an objective element of the post-update structured document 400.

When an objective element is included in a plurality of partial structures and these objective elements are correspond to a plurality of elements in the post-update structured document 400, the objective element estimation unit 16 may estimate an element which corresponds to the largest number of partial structures as an objective element.

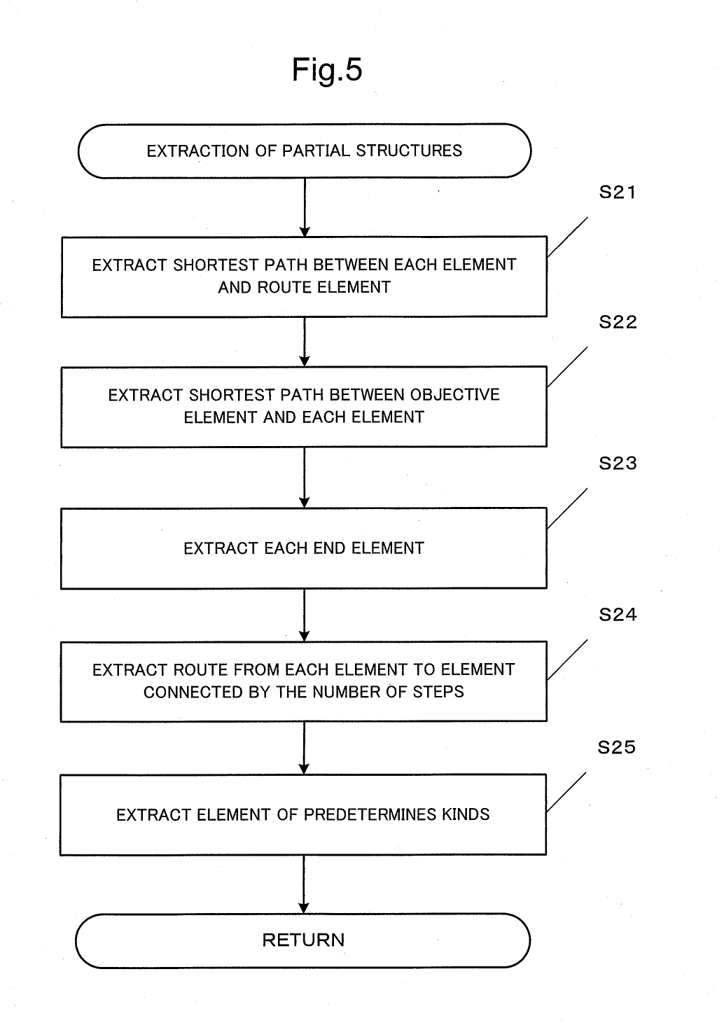

Operations of the search formula update device 11 configured as above will be described using FIGS. 5-7. Meanwhile, although the search formula update device 11 carries out operations shown in FIGS. 2-3 like the search formula update device 1 of the first exemplary embodiment of the present invention, there is a difference in operations in Step S1, Step S3 and Step S4.

First, the extraction operation of partial structures in Step S1 of the search formula update device 11 will be described using FIG. 5.

Here, first, the partial structure extraction unit 13 extracts the shortest path of each element constituting the structure information 301 from a route element as a partial structure, respectively (Step S21).

Next, the partial structure extraction unit 13 extracts the shortest path from an objective element specified by the search formula 302 to each element as a partial structure, respectively (Step S22).

Next, the partial structure extraction unit 13 extracts each end element, respectively, as a partial structure (Step S23).

Next, the partial structure extraction unit 13 extracts a route from each element to an element which is connected to the original element by the number of steps set in advance, respectively, as a partial structure (Step S24).

Next, the partial structure extraction unit 13 extracts, among the respective elements, each element of kinds set in advance, respectively, as a partial structure (Step S25).

By this, the partial structure extraction unit 13 ends the extraction operation of partial structures, and the operation of the search formula update device 11 returns to Step S2 of FIG. 2.

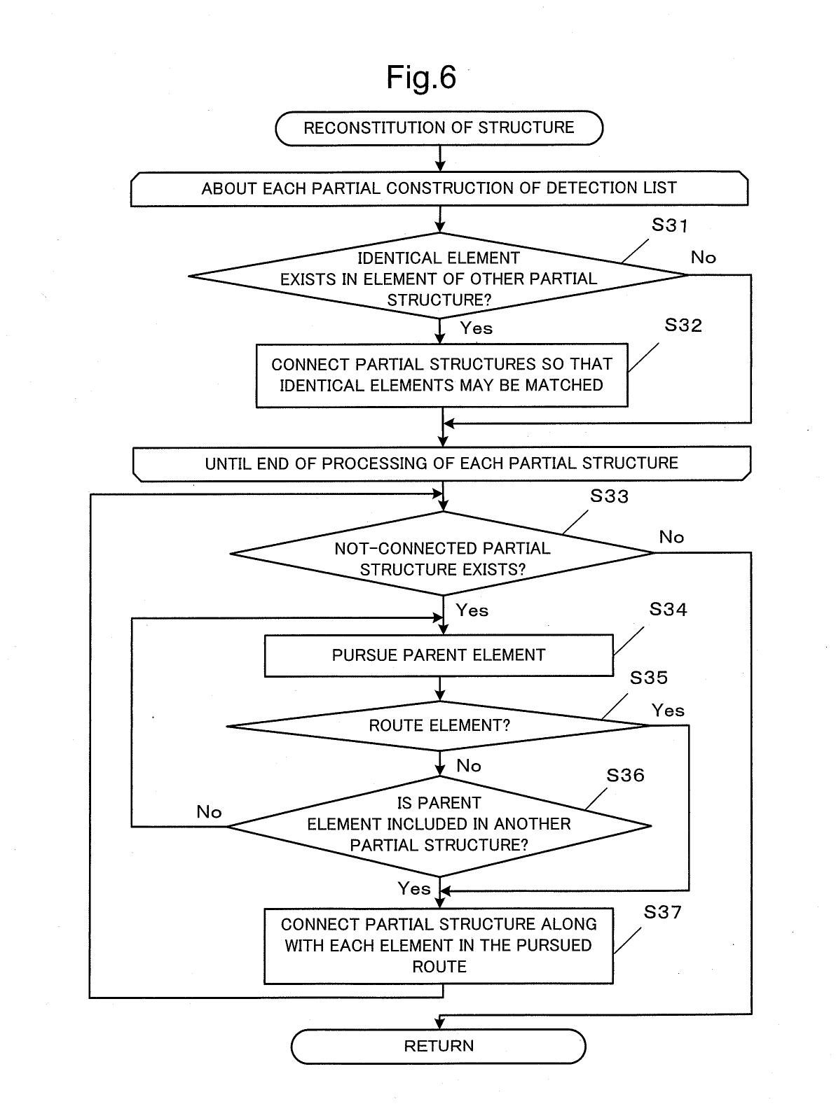

Next, the reconstitution operation of a structure by the search formula update device 11 in Step S3 will be described using FIG. 6.

Here, first, the structure reconstitution unit 15 determines, about each partial structure added to a detection list by the partial structure detection unit 4 in Step S2, whether an identical element is included in another partial structure in the post-update structured document 400 or not (Step S31).

Here, when it is determined that an element identical with that of another partial structure is included, the structure reconstitution unit 15 connects this partial structure and the other partial structure so that identical elements may be matched (Step S32).

The structure reconstitution unit 15 performs processing of Steps S31-S32 about each partial structure of the detection list.

Next, the structure reconstitution unit 15 determines whether there is a partial structure being not connected to any of the partial structures that are connected including a route element (Step S33).

Here, when it is determined that there is a partial structure not connected to any of the partial structure connected including the route element (in Step S33, Yes), the structure reconstitution unit 15 detects the parent element of this partial structure in the post-update structured document 400 (Step S34).

Next, the structure reconstitution unit 15 determines whether the detected parent element is a route element or not (Step S35).

Here, when determining that the parent element is not a route element (in Step S35, No), it is then judged whether the detected parent element is included in one of the partial structures connected including the route element or not (Step S36).

Here, when a parent element is judged not to be included in any of the partial structures connected including the route element (in Step S36, No), the operation returns to Step S34, and the structure reconstitution unit 15 detects the parent element of the parent element detected in the last Step S34.

On the other hand, when judging that the parent element is the route element (in Step S35, Yes), or when judging that it is included in one of the partial structures connected including the route element (in Step S36, Yes), the structure reconstitution unit 15 connects this partial structure to the reached element including each element in the pursued route (Step S37). After that, the operation of the structure reconstitution unit 15 returns to Step S33.

In Step S33, when it is determined that there is not a partial structure not connected to any of the partial structure connected including the route element (in Step S33, No), the structure reconstitution unit 15 ends the operation to reconstitute the structure, and the operation of the search formula update device 11 returns to Step S4 of FIG. 2.

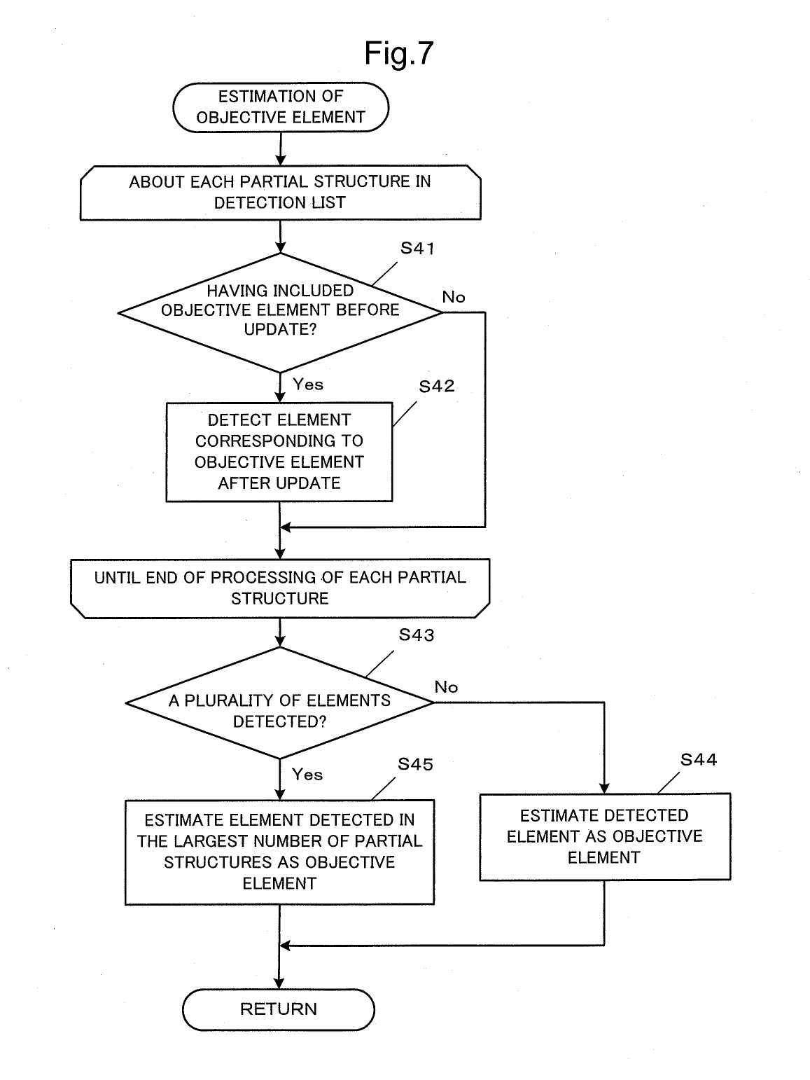

Next, the estimation operation of an objective element by the search formula update device 11 in Step S4 will be described using FIG. 7.

Here, first, the objective element estimation unit 16 judges, about each partial structure added by the partial structure detection unit 4 to the detection list in Step S2, whether it has included an objective element specified by the search formula 302 in the structure information 301 before update or not (Step S41).

Here, when it is determined that the objective element has been included (in Step S41, Yes), the objective element estimation unit 16 detects an element to which the objective element having been included in this partial structure corresponds in the post-update structured document 400 (Step S42).

The objective element estimation unit 16 performs processing of Steps S41-S42 about each partial structure included in the detection list.

Next, the objective element estimation unit 16 judges whether a plurality of elements are detected as elements which are identical with the objective element (Step S43).

Here, when only one element is detected (in Step S43, No), the objective element estimation unit 16 estimates the detected element as an objective element (Step S44).

On the other hand, when a plurality of elements are detected (in Step S43, Yes), the objective element estimation unit 16 estimates an element detected in the largest number of partial structures as an objective element (Step S45).

By this, the objective element estimation unit 16 ends its operation for estimating an objective element, and the operation of the search formula update device 11 returns to Step S5 of FIG. 2.

The search formula update device 11 updates the search formula 302 so that an objective element estimated by the objective element estimation unit 16 may be specified using the structure information 401 reconstituted by the structure reconstitution unit 15, and generates a search formula 402.

The search formula 402 is a search formula corresponding to the post-update structured document 400.

By this, description of the operation of the search formula update device 11 is finished.

Next, an effect of the second exemplary embodiment of the present invention will be described.

A search formula update device as the second exemplary embodiment of the present invention can reconstitute the structure of a structured document after update with higher accuracy.

The reason of this is that, because partial structures including identical elements are connected so that identical elements may match, and, about a partial structure not connected to any of partial structures connected including the route element, a parent element is pursued and connected, it is possible to perform reconstitution by connecting more partial structures.

Specifically, the reason is that the following structure is included. That is, first, the structure reconstitution unit 15 connects partial structures detected by the partial structure detection unit 4 from the post-update structured document 200 so that they may conform to the structure of the post-update structured document 200, and reconstitutes the structure information 201 of the post-update structured document 200. Secondly, the structure reconstitution unit 15 pursues, about a partial structure not connected to any of partial structures connected including a route element in the post-update structured document 400, a parent element until an element which is included in one of the partial structures connected including the route element or a route element is reached. Thirdly, the structure reconstitution unit 15 connects a partial structure, which is not being connected, to the reached element along with the pursued route.

Another reason is that, because a shortest path from each element constituting structure information before update to a route element is extracted as a partial structure in advance, a part for which a path from a route element is not changed in the structured document after update can be detected with higher accuracy.

Specifically, the reason of this is that the partial structure extraction unit 13 extracts the shortest path from an objective element specified by the search formula 302 to each element as a partial structure.

Yet another reason is that, because each end element is extracted as a partial structure, even if there is a large change in relation between elements in the post-update structured document, it is possible to detect an end element that has not been changed.

Specifically, the reason of this is that the partial structure extraction unit 13 extracts each end element as a partial structure.

Yet another reason is that, because a route from each element to an element which is connected by the number of steps of a number decided in advance is extracted as a partial structure, when a middle hierarchy is inserted in the post-update structured document, a part which corresponds to a part before update can be detected with higher accuracy.

Specifically, the reason of this is that, because the partial structure extraction unit 13 extracts a route from each element to an element which is connected by the number of steps set in advance as a partial structure.

A search formula update device as the second exemplary embodiment of the present invention can estimate an objective element in the post-update structured document with higher accuracy.

The reason is that, among partial structures detected from an structured document after update, an element to which a partial structure having been including an objective element correspond is estimated as an objective element, and, further, when a plurality of elements are corresponded to, an element which corresponds to the largest number of partial structures is estimated as an objective element.

Specifically, the reason of this is that the objective element estimation unit 16 estimates an element detected in the largest number of partial structures as an objective element.

Another reason is that, because a shortest path from an objective element specified by a search formula before update to each element is extracted as a partial structure, a part for which a route to the objective element is not changed can be estimated with higher accuracy in a structured document after update. Specifically, the reason of this is that the partial structure extraction unit 13 extracts a shortest path from an objective element specified by the search formula 302 to each element as a partial structure.

A search formula update device as the second exemplary embodiment of the present invention can detect an element which is used as a condition to specify an objective element when a search formula is updated with higher accuracy.

The reason of this is that, because a shortest path from an objective element specified by a search formula before update to each element is extracted as a partial structure, an element for which relative relation with the objective element is indicated by a shortest path can be detected easily.

Specifically, the reason is that the partial structure extraction unit 13 extracts a shortest path from an objective element specified by the search formula 302 to each element as a partial structure.

Another reason is that, by extracting an element of kinds set in advance as a partial structure, when such partial structure is detected in a structured document after update, it can be used as a condition to search for (specify) an objective element.

Specifically, the reason of this is that the partial structure extraction unit 13 extracts each element of kinds set in advance among each element as a partial structure.

### The Third Exemplary Embodiment

Next, the third exemplary embodiment of the present invention will be described in detail using a drawing.

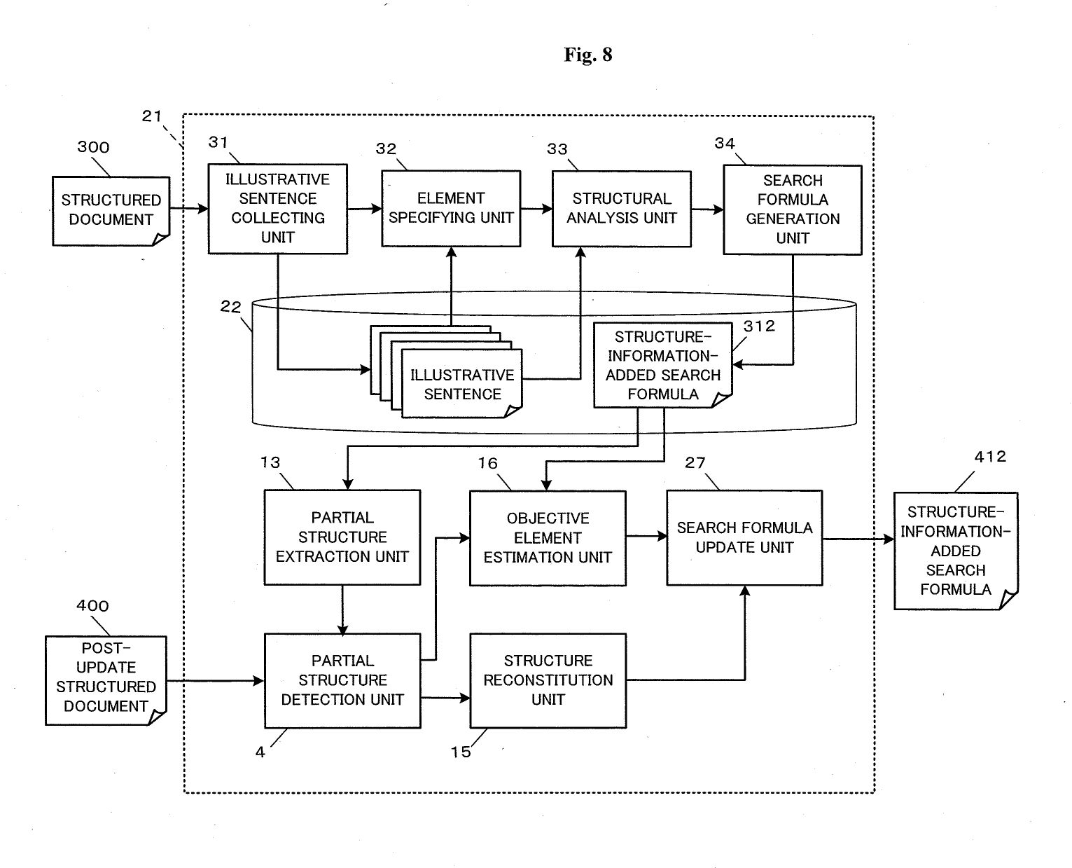

A structure of a search formula update device 21 as the third exemplary embodiment of the present invention is shown in FIG. 8. Meanwhile, in FIG. 8, an identical code is attached to a structure identical with that of the search formula update device 1 as the first embodiment of the present invention and the search formula update device 11 as the second exemplary embodiment, and detailed description will be omitted.

The search formula update device 21 is different from the search formula update device 11 as the second exemplary embodiment of the present invention in a point that it is provided with a storage unit 22 in place of the storage unit 2, and a search formula update unit 27 in place of the search formula update unit 7. Also, the search formula update device 21 is different from the search formula update device 11 in a point that it further includes an illustrative sentence collecting unit 31, an element specifying unit 32, a structural analysis unit 33 and a search formula generation unit 34.

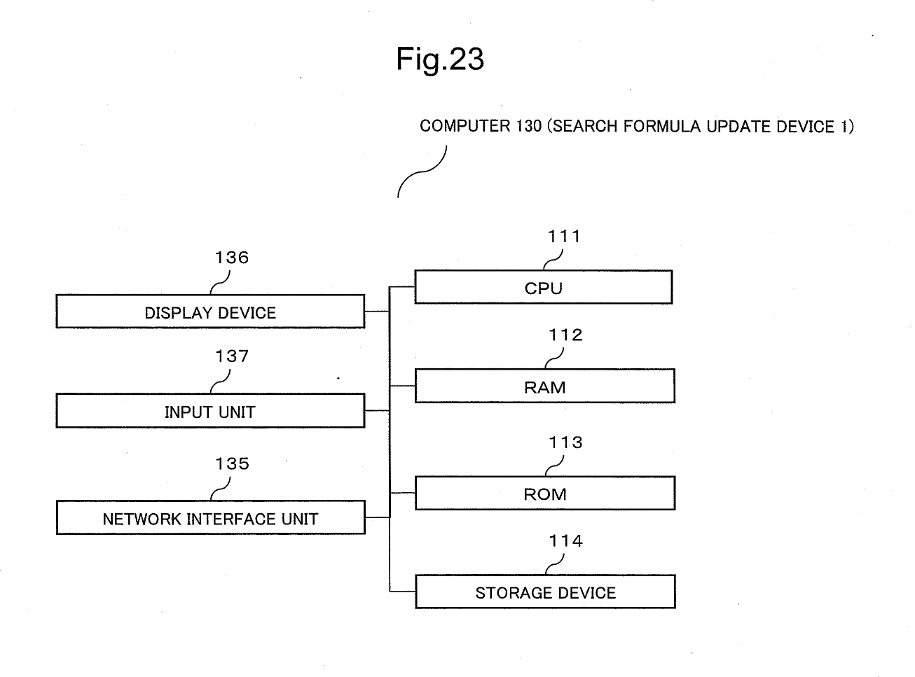

Here, the search formula update device 21 may be composed of a general-purpose computer 130 as shown in FIG. 23.

Referring to FIG. 23, the computer 130 includes the CPU 111, the RAM 112, the ROM 113, the storage device 114, a display device 136, an input unit 137 and a network interface unit 135. The storage unit 22 is configured by the storage device 114 of the computer 130. In this case, the illustrative sentence collecting unit 31, the element specifying unit 32, the structural analysis unit 33, the search formula generation unit 34 and the search formula update unit 27 correspond to the CPU 111, the RAM 112, the ROM 113 and the storage device 114. Programs to be executed by the CPU 111 are stored in the storage device 114. Further, modules of each of the above-mentioned programs may be stored in the ROM 113.

The CPU 111 reads a program stored in the storage device 114 into the RAM 112, and carries out predetermined processing based on the program which has been read.

The network interface unit 135 sends and receives control information and processing target data between the search formula update device 21 and an external apparatus based on directions of the CPU 111. The network interface unit 135 may be included in the partial structure detection unit 4 and the illustrative sentence collecting unit 31.

The display device 136 shows information to a user based on directions of the CPU 111. The display device 136 may be included in the element specifying unit 32.

The input unit 137 accepts user's input based on directions of the CPU 111. The input unit 137 may be included in the element specifying unit 32.

Meanwhile, as is the case with the general-purpose computer 110 shown in FIG. 22, the recording medium 117 may memorizes a code of a program (software) executed by the computer 130 (CPU 111) temporarily or non-temporarily. It may be such that the recording medium 117 is supplied to the computer 130, and the CPU 111 read the codes of a program stored in the recording medium 117 and carry it out. Or, the CPU 111 may store the codes of a program stored in the recording medium 117 in the RAM 112.

In FIG. 8, the illustrative sentence collecting unit 31 acquires illustrative sentences of a structured document 300 to be a search object, and stores them in the storage unit 22.

For example, the illustrative sentence collecting unit 31 may acquire an illustrative sentence of the structured document 300 from a not-illustrated server connected to outside via a network interface.

Here, a suitable example of an illustrative sentence of the structured document 300 acquired by the illustrative sentence collecting unit 31 is an HTML document.

The illustrative sentence collecting unit 31 stores the acquired illustrative sentences of the structured document 300 into the storage unit 22 in a manner being correlated with a document name representing a kind of a document.

Here, a kind of a document indicates documents outputted for an identical purpose by an identical application. For example, the illustrative sentence collecting unit 31 correlates illustrative sentences of the structured document 300 with a document name representing a kind of a document such as a condition input page, a result list page or a detail indication page.

As a suitable example of a document name representing a kind of a document, the title of a document described in an illustrative sentence of the structured document 300 and URL (Uniform Resource Locator) for acquiring the structured document 300 and the like are cited.

Meanwhile, as a document name which is correlated to an illustrative sentence of the acquired structured document 300, the illustrative sentence collecting unit 31 may acquire information specified by a user from the input unit.

The illustrative sentence collecting unit 31 may set a unique illustrative sentence identifier to each illustrative sentence of the structured document 300.

The storage unit 22 accumulates the illustrative sentences of the structured document 300 acquired by the illustrative sentence collecting unit 31 along with document names correlated by the illustrative sentence collecting unit 31. Further, the storage unit 22 composes one exemplary embodiment of structured document storage means in the present invention.

The element specifying unit 32 specifies an objective element to be a search object in the illustrative sentences of the structured document 300 accumulated in the storage unit 22.

For example, the element specifying unit 32 displays the illustrative sentences of the structured document 300 on a display device, and may acquire an objective element to be a search object via the input unit.

The element specifying unit 32 outputs information which identifies an illustrative sentence of the structured document 300, an identifier which identifies an objective element of a search object and a detection object to the structural analysis unit 33.

Here, a suitable example of information which identifies an illustrative sentence is an illustrative sentence identifier set by the illustrative sentence collecting unit 31.

Also, a suitable example of an identifier that identifies an objective element of a search object is an identifier of each element set to an illustrative sentence in advance. Another suitable example is an identifier added by the element specifying unit 32 to each element of an illustrative sentence. Yet another suitable example is a number when counting the number of elements in an illustrative sentence in sequence from the head. Yet further suitable example is a search formula made by lining an element name for tracking from a head element to a relevant element in an illustrative sentence and a numerical value which indicates a position in a brother element in turn.

The structural analysis unit 33 acquires, based on information which identifies an illustrative sentence inputted from the element specifying unit 32, a plurality of illustrative sentences correlated to a document kind identical with this illustrative sentence from the storage unit 22 and analyzes them. The structural analysis unit 33 detects an element included in a plurality of illustrative sentences in common as an element constituting a structure in this documentary kind.

The search formula generation unit 34 generates a structure-information-added search formula 312 using an element detected by the structural analysis unit 33. The generated structure-information-added search formula 312 is stored in the storage unit 22.

The structure-information-added search formula 312 is a search formula with structure information corresponding to a structured document before update.

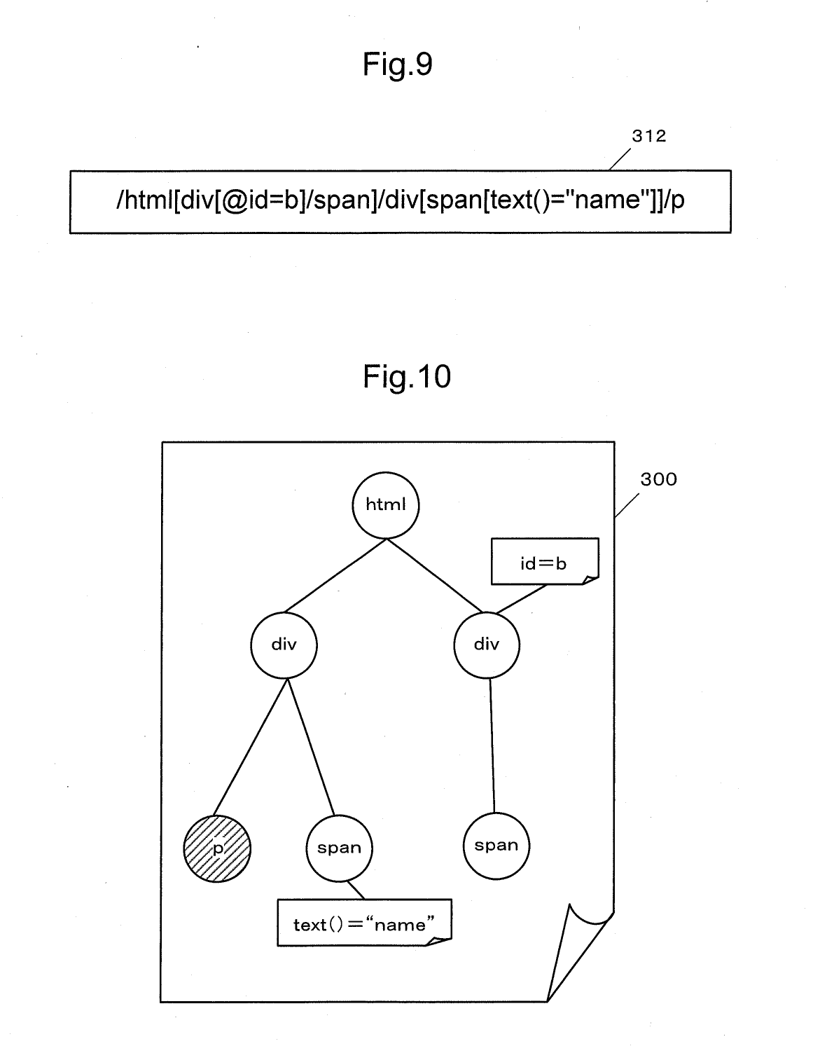

Here, the structure-information-added search formula 312 is constituted so that a search formula which specifies an objective element may represent structure information of a structured document. An example of the structure-information-added search formula 312 is shown in FIG. 9.

In FIG. 9, the structure-information-added search formula 312 is expressed by XPath Formula. The structure-information-added search formula 312 specifies an objective element p in the structured document 300 having structure information shown in FIG. 10, and, also, expresses this structure information. That is, the structure-information-added search formula 312 expresses structure information by using elements of which structure information shown in FIG. 10 is composed as a condition to specify the objective element p.

Meanwhile, the search formula generation unit 34 may generate the structure-information-added search formula 312 that uses all commonly existing elements detected by the structured document analysis unit 33. The search formula generation unit 34 may generate the structure-information-added search formula 312 using a part of the elements existing in common.

The search formula update unit 27 updates the structure-information-added search formula 312 and generates a structure-information-added search formula 412 so that an objective element estimated by the objective element estimation unit 16 may be specified using an element of the structure of the post-update structured document 400 reconstituted by the structure reconstitution unit 15 as a condition.

The structure-information-added search formula 412 is a structure-information-added search formula corresponding to the post-update structured document 400.

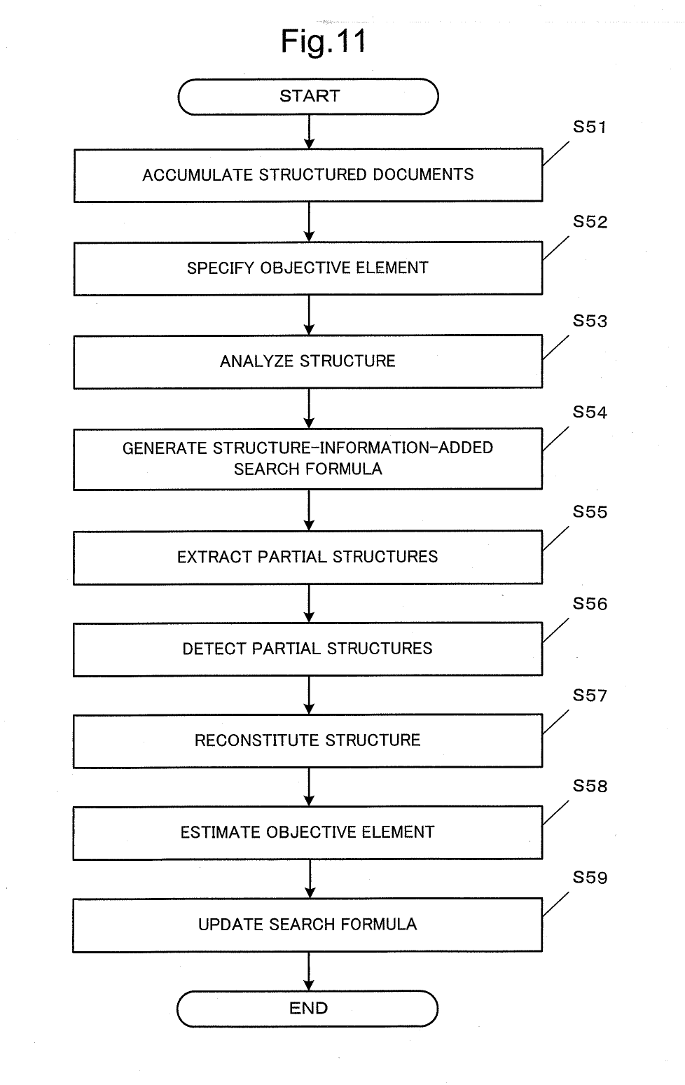

Operations of the search formula update device 21 configured like the above will be described using FIG. 11.

First, the illustrative sentence collecting unit 31 collects an illustrative sentence of the structured document 300 and accumulates them in the storage unit 22 (Step S51).

Next, the element specifying unit 32 specifies an objective element to be a search object in the illustrative sentence of the structured document 300 (Step S52). The element specifying unit 32 outputs information for identifying the illustrative sentence and information for identifying the specified objective element to the structural analysis unit 33.

Next, the structural analysis unit 33 acquires no smaller than one illustrative sentence of the structured document 300 of a document kind identical with this illustrative sentence from the storage unit 22 based on the information for identifying the illustrative sentence and analyzes its structure (Step S53). Specifically, the structural analysis unit 33 detects an element common to the no smaller than one illustrative sentence.

Next, the search formula generation unit 34 generates the structure-information-added search formula 312 that specifies an objective element to be a search object in the structured document 300 using the common element detected in Step S53 (Step S54).

Next, the partial structure extraction unit 13 extracts partial structures from structure information represented by the structure-information-added search formula 312 (Step S55).

Next, the partial structure detection unit 4 detects, among the partial structures extracted in Step S55, ones which compose the structure of the post-update structured document 400 (Step S56).

Next, the structure reconstitution unit 15 reconstitutes the structure of the post-update structured document 400 by connecting the partial structures detected in Step S56 (Step S57).

Next, the objective element estimation unit 16 estimates an objective element in the structure reconstituted in Step S57 based on the partial structures detected in Step S56 and the structure-information-added search formula generated in Step S54 (Step S58).

Next, the search formula update unit 27 updates the structure-information-added search formula 312 using the structure reconstituted in Step S57 to generate the structure-information-added search formula 412 (Step S59).

By the above, the search formula update device 21 finishes operating.

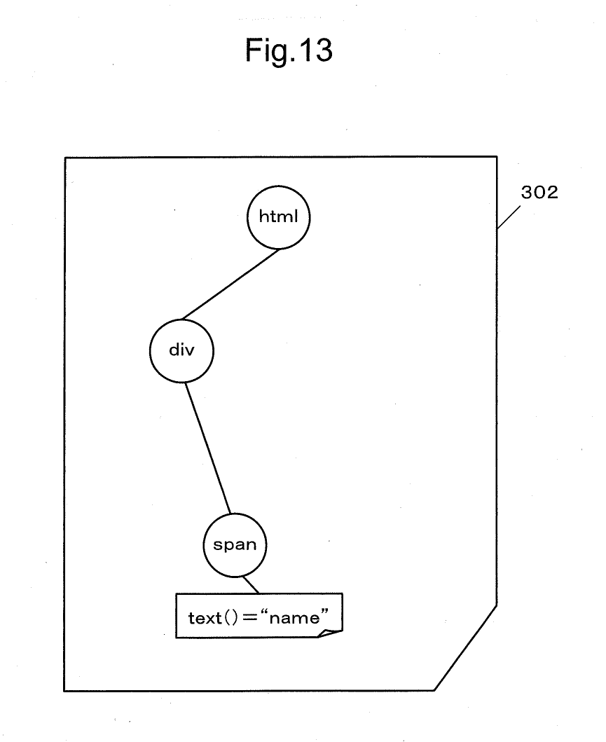

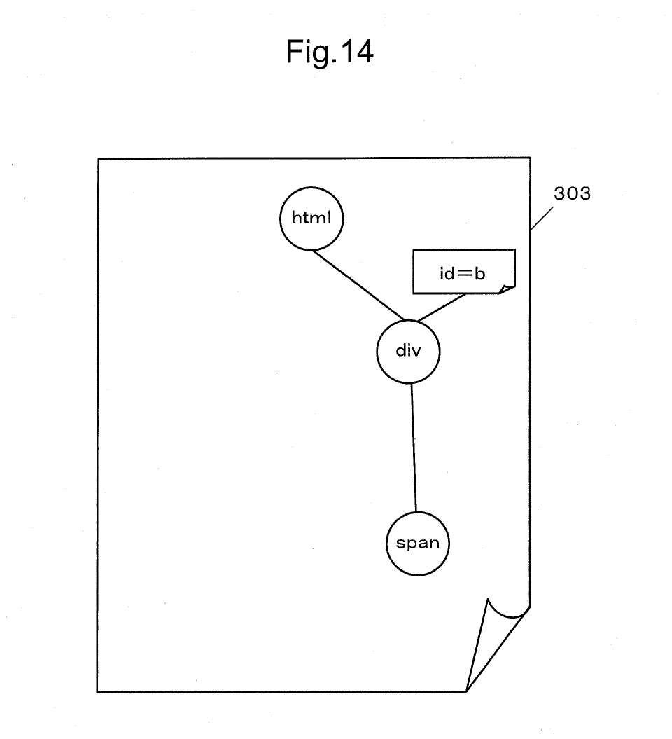

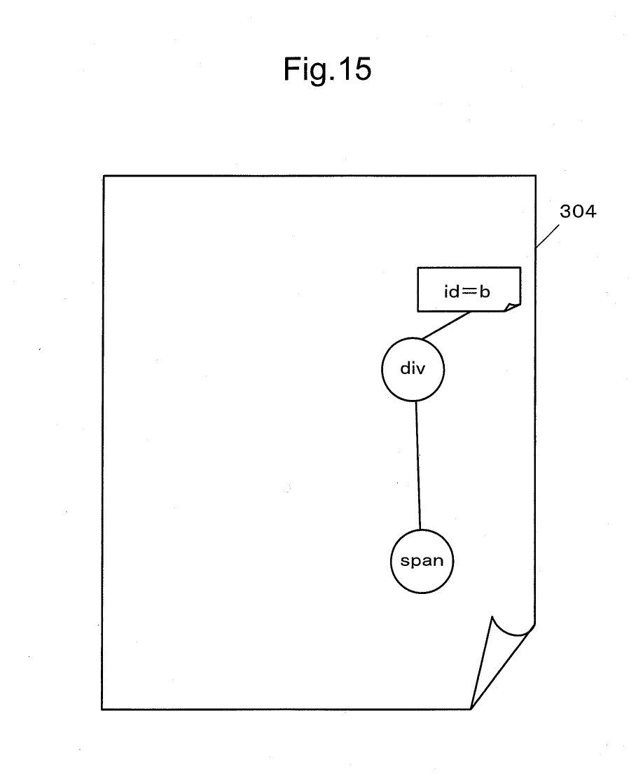

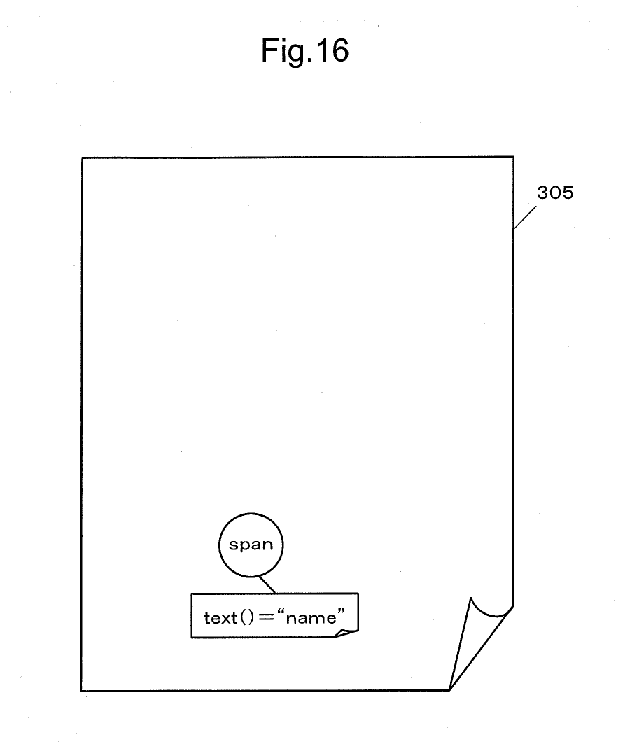

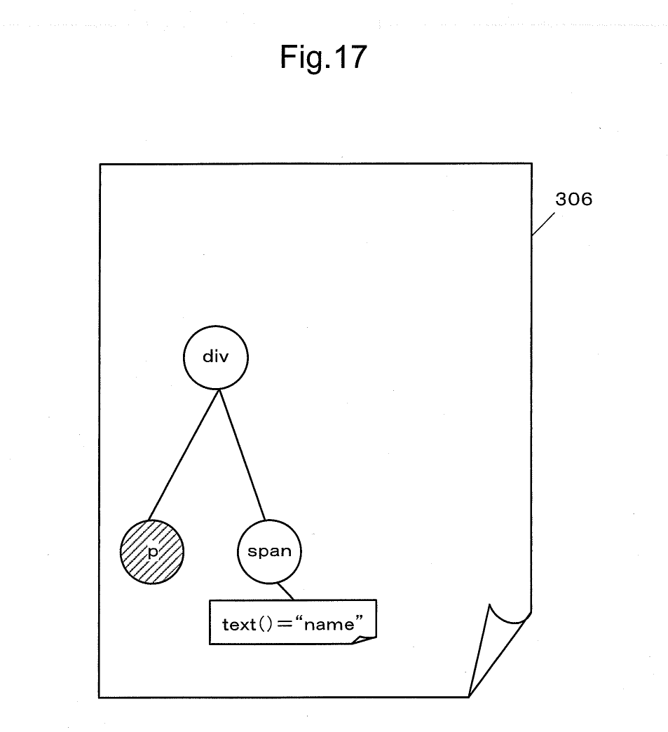

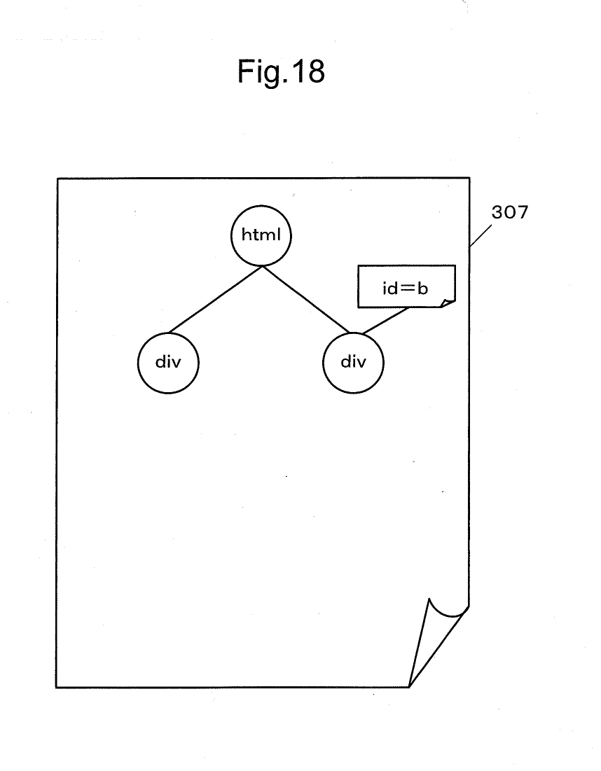

Next, a specific example of an operation by which the search formula update device 21 updates a search formula will be described using FIGS. 9-21.

First, the illustrative sentence collecting unit 31 accumulates an illustrative sentence of the structured document 300 having the structure shown in FIG. 10 (Step S51).

Next, the element specifying unit 32 displays the illustrative sentence of the structured document 300 on a display device, and specifies an element p as an objective element based on information inputted by a user via an input unit (Step S52).

Next, the structural analysis unit 33 analyzes a structure from no smaller than one illustrative sentence of the structured document 300, and detects an element shown in FIG. 10 (Step S53).

Next, the search formula generation unit 34 generates the structure-information-added search formula 312 (FIG. 9) that specifies the objective element p in the structured document 300 (Step S54).

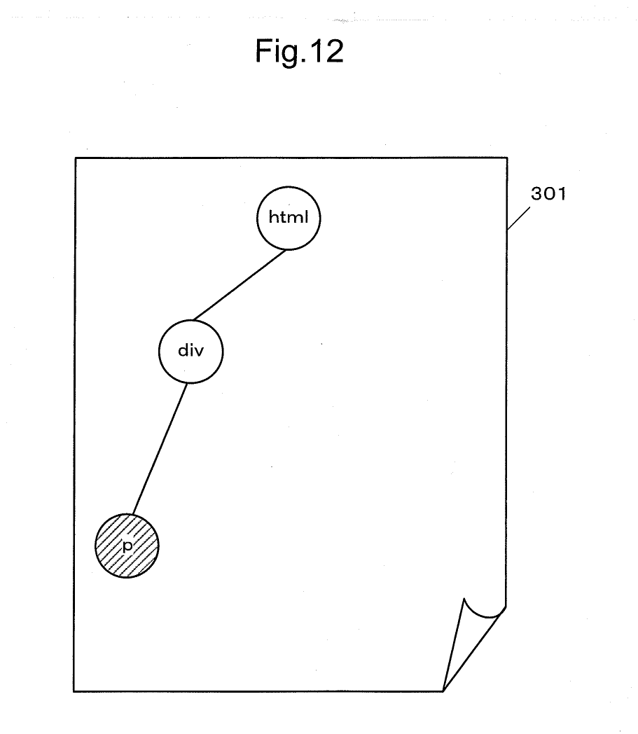

Next, the partial structure extraction unit 13 extracts partial structures 301-307 shown in FIGS. 12-18 from the structure information shown in FIG. 10, respectively, based on the structure-information-added search formula 312 (Step S55).

Here, the partial structures 301-303 are ones extracted as a shortest path from each element to the route element in the structure information represented by the structure-information-added search formula 312.

the partial structures 304-305 are partial structures which are made by extracting an element having a predetermined kind in the structure information represented by the structure-information-added search formula 312. For example, the partial structure 304 has been extracted as an element having an id attribute, and the partial structure 305 has been extracted as an element with a text attribute.

The partial structures 306-307 and a partial structure 304 have been extracted as a route from each element to an element which is connected by the predetermined number of steps in the structure information represented by the structure-information-added search formula 312. Meanwhile, partial structures extracted overlapping with each other like a partial structure 304 are processed as an identical partial structure.

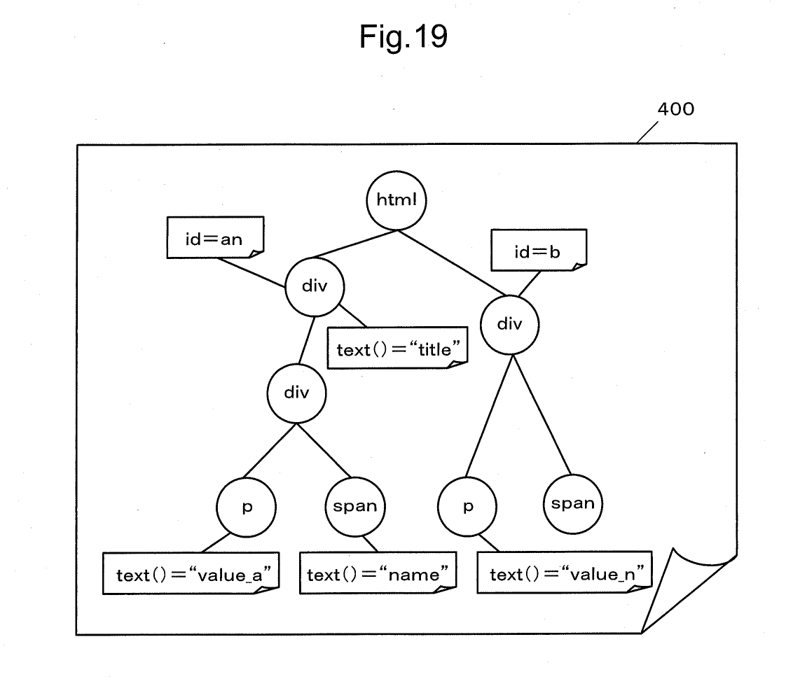

Next, the partial structure detection unit 4 acquires the post-update structured document 400 having the structure shown in FIG. 19. Then, the partial structure detection unit 4 detects, among the partial structures 301-307, the partial structures 303-307 as ones constituting the structure of the post-update structured document 400 (Step S56).

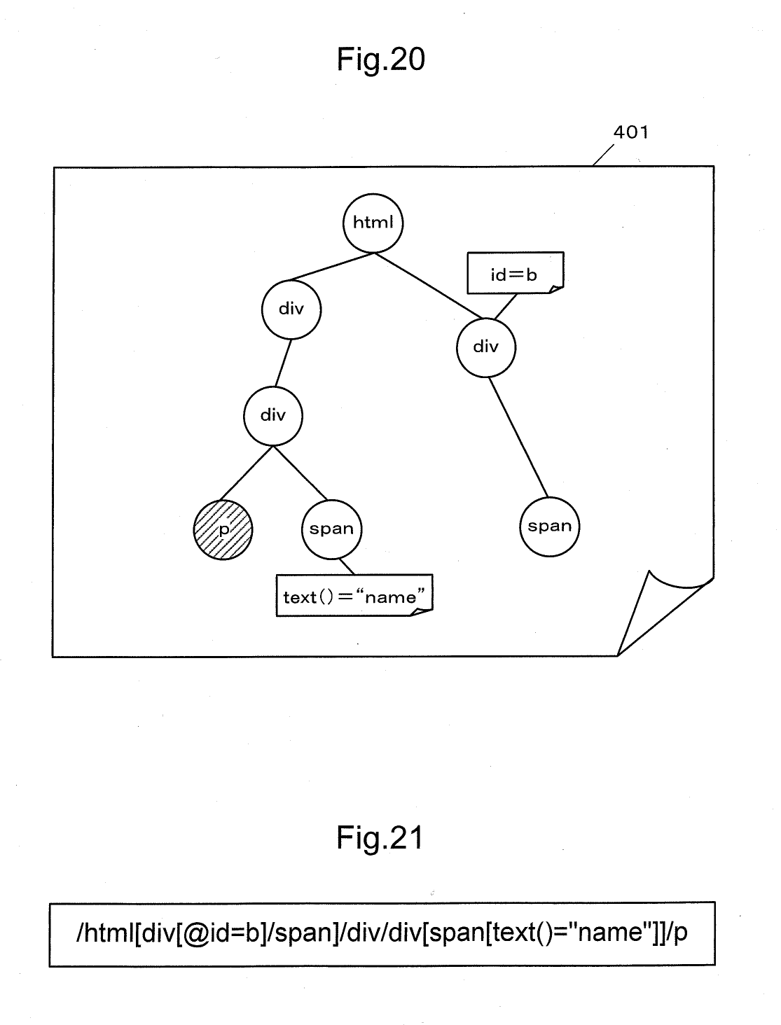

Next, the structure reconstitution unit 15 connects the partial structures 303-307, and reconstitutes the structure information 401 shown in FIG. 20 (Step S57).

Specifically, because partial structures 303, 304 and 307 include an identical element in the post-update structured document 400, respectively, the structure reconstitution unit 15 connects them so that the identical elements may be matched. Because the partial structures 305 and 306 include identical elements in the post-update structured document 400, respectively, the structure reconstitution unit 15 connects them so that the identical elements may be matched.

Because the partial structure 306 is not connected with any of the partial structures 303, 304 and 307 that are connected including the route element, the structure reconstitution unit 15 pursues a parent element from the div element of the post-update structured document 400 with which the div element which is the vertex of the partial structure 306 fits. Then, the structure reconstitution unit 15 reaches an element with which the div element of the left side of the partial structure 307 fits. Accordingly, the structure reconstitution unit 15 connects the div element which is the vertex of the partial structure 306 as a child element of the div element of the left side of the partial structure 307. That is, the structure reconstitution unit 15 connects the partial structure 306 and the partial structure 307 along with the route through which the parent element has been pursued.

Next, because the objective element has been included in the partial structure 306 among the partial structures 303-307, the objective element estimation unit 16 estimates an element which corresponds in the post-update structured document 400 to the objective element having been included in the partial structure 306 as an objective element (Step S58).

Next, the search formula update unit 27 reconstitutes the structure-information-added search formula 412 shown in FIG. 21 so that the objective element which has been estimated in the structure information of FIG. 20 reconstituted in Step S57 may be specified (Step S59).

As above, the search formula update device 21 updates a search formula.

Next, an effect of the third exemplary embodiment of the present invention will be described.

Even when structure information is not stored in advance, a search formula update device as the third exemplary embodiment of the present invention can update a search formula of a structured document with higher accuracy according to a change in its structure and content.

The reason of this is that, by generating a search formula with structure information from an illustrative sentence of a structured document, it is possible to reconstitute the structure of a post-update structured document based on structure information which is represented by the generated search formula.

Specifically, the reason is that the following structures are included. That is, first, based on information for identifying an illustrative sentence inputted from the element specifying unit 32, the structural analysis unit 33 acquires a plurality of illustrative sentences correlated to a document kind identical with that of this illustrative sentence from the storage unit 22 and analyzes them. Secondly, the structural analysis unit 33 detects elements included in the plurality of illustrative sentences in common as elements constituting the structure in this document kind. Thirdly, the search formula generation unit 34 generates the structure-information-added search formula 312 using the element having been detected by the structural analysis unit 33.

Because a search formula update device as the third exemplary embodiment of the present invention performs structural analysis of a collected structured document, it can detects that the structure of the structured document has been updated.

Specifically, based on information for identifying an illustrative sentence inputted from the element specifying unit 32, the structural analysis unit 33 acquires a plurality of illustrative sentences correlated to a document kind identical with that of this illustrative sentence from the storage unit 22 and analyzes them.

Meanwhile, each exemplary embodiment mentioned above can be carried out in a manner combined appropriately.

Also, the present invention is not limited to each exemplary embodiment mentioned above, and it is possible to be carried out in various aspects.

Although the above-mentioned exemplary embodiments can also be described as, but not limited to, the whole or part of the following supplementary notes.

(Supplementary note 1)

A search formula update device, comprising:

a partial structure extraction means which extracts part of partial structures from structure information on a structured document;

a partial structure detection means which detects, among said partial structures, partial structures constituting a structure of a post-update structured document made by updating said structured document;

a structure reconstitution means which reconstitutes structure information on said post-update structured document by connecting the partial structures detected by said partial structure detection means;

an objective element estimation means which estimates an objective element of said post-update structured document, said objective element corresponding to an objective element specified by a search formula in said structured document, based on the partial structures detected by said partial structure detection means and said search formula; and

a search formula update means which updates said search formula using the structure information reconstituted by said structure reconstitution means such that the objective element estimated by said objective element estimation means is specified in said post-update structured document.

(Supplementary note 2)

The search formula update device according to supplementary note 1, further comprising:

a structured document storage means which accumulates said structured documents;

a structure information analysis means which analyzes said structure information from said structured documents accumulated;

a search formula generation means which generates said search formula such that said structure information is represented; and

said partial structure extraction means extracting said partial structure from said structure information expressed by said search formula.

(Supplementary note 3)

The search formula update device according to supplementary note 1 or 2, wherein

structure information on said structured document is expressed by a tree structure including a set of elements; and wherein

said partial structure extraction means extracts one of: one of a shortest path of each of said elements from a route element, a shortest path of each of said elements from said objective element, each end element, a route from each of said elements to an element connected by a number of steps set in advance and each element of a kind set in advance among each of said elements; and combinations thereof, respectively, as said partial structure.

(Supplementary note 4)

The search formula update device according to supplementary note 3, wherein,

when, among the partial structures detected by said partial structure detection means from the post-update structured document, the partial structure not connected to any of the partial structures connected in a manner including a route element in said post-update structured document exists, about the not-connected partial structure, said structure reconstitution means pursues a parent element until one of said route element and an element included in one of the partial structures connected in a manner including said route element is reached, and connects the not-connected partial structure to the reached element along with a pursued route.

(Supplementary note 5)

The search formula update device according to any one of supplementary notes 1 to 4, wherein

said objective element estimation means estimates, among the partial structures detected from said post-update structured document, an element corresponding to, in the partial structure having included said objective element prior to update, said objective element as the objective element in said post-update structured document.

(Supplementary note 6)

The search formula update device according to supplementary note 5, wherein,

when a plurality of elements can be estimated as said objective element in said post-update structured document, said objective element estimation means estimates, among said plurality of elements, the element included in a most larger number of said partial structures in said post-update structured document as said objective element.

(Supplementary note 7)

The search formula update device according to any one of supplementary notes 1 to 6, wherein

said structured document is an XML (Extensible Markup Language) document, and said search formula is XPath (XML Path Language) Formula.

(Supplementary note 8)

A search formula update method, comprising the steps, carried out by a search formula update device for updating a search formula for specifying an objective element of a structured document, of:

extracting part of partial structures from structure information on a structured document;

detecting, among said extracted partial structures, partial structures constituting a structure of a post-update structured document made by updating said structured document;

reconstituting structure information on said post-update structured document by connecting said detected partial structures;

estimating an objective element of said post-update structured document, said objective element corresponding to an objective element of said structured document, based on said detected partial structures and said search formula; and

updating said search formula, based on said reconstituted structure information and said estimated objective element, such that said objective element is specified in said post-update structured document.

(Supplementary note 9)

The search formula update method according to supplementary note 8, wherein

said search formula update device

accumulates said structured document in a storage device;

analyzes said structure information from said structured document accumulated in said storage device;

generates said search formula such that said structure information is represented; and,

said extracting partial structures extracts said partial structures from said structure information represented by said search formula.

(Supplementary note 10)

A recording medium storing a search formula update program for causing a computer to execute:

processing of extracting part of partial structures from structure information on said structured document;

processing of detecting, among the partial structures extracted by said processing of extracting partial structures, partial structures constituting a structure of a post-update structured document made by updating said structured document;

processing of reconstituting structure information on said post-update structured document by connecting the partial structures detected by said processing of detecting partial structures constituting said structure;

processing of estimating an objective element of said post-update structured document, said objective element corresponding to an objective element of said structured document, based on said detected partial structures and said search formula; and

processing of updating said search formula, based on said reconstituted structure information and said objective element estimated by said processing of estimating an objective element, such that said objective element is specified in said post-update structured document.

(Supplementary note 11)

The recording medium storing a search formula update program according to supplementary note 10, further causing said computer to carry out:

processing of accumulating said structured document in a storage device;

processing of analyzing said structure information from said structured document accumulated in said storage device;

processing of generating said search formula such that said structure information is represented; and,

said processing of extracting partial structures is processing of extracting said partial structures from said structure information represented by said search formula.

Although the present invention has been described with reference to an exemplary embodiment above, the present invention is not limited to the above-mentioned exemplary embodiments. Various modifications which a person skilled in the art can understand can be performed in the composition and details of the present invention within the scope of the present invention.

This application claims priority based on Japanese application Japanese Patent Application No. 2010-043957, filed on Mar. 1, 2010, the disclosure of which is incorporated herein in its entirety.

### INDUSTRIAL APPLICABILITY

The present invention can provide a search formula update device which can update a search formula which specifies an element of a structured document with higher accuracy according to a change in the structure and content, and, for example, it is suitable as a structured document processor which performs processing, about a structured document or the like exhibited on the internet and the intranet, such as a test of its structure, or acquisition or rewriting of the content of a specified element.

### DESCRIPTION OF THE REFERENCE NUMERALS

1, 11, 21 Search formula update device
2, 22 Storage unit
3, 13 Substructure extraction unit
4 Substructure detection unit
5, 15 Structure reconstitution unit
6, 16 Target element estimation unit
7, 27 Search formula update unit
31 Illustrative sentence collecting unit
32 Element specifying unit
33 Structured document analysis unit
33 Structural analysis unit
34 Search formula generation unit
101, 201, 301, 401 Structure information
102, 202, 302, 402 Search formula
200, 400 After-update structured document
300 Structured document
301, 302, 303, 304, 305, 306, 307 Substructure
312, 412 Structure-information-added search formula

1-10. (canceled)

11. A search formula update device, comprising:
partial structure extraction unit which extracts part of partial structures from structure information on a structured document;
partial structure detection unit which detects, among said partial structures, partial structures constituting a structure of a post-update structured document made by updating said structured document;
structure reconstitution unit which reconstitutes structure information on said post-update structured document by connecting the partial structures detected by said partial structure detection unit;
objective element estimation unit which estimates an objective element of said post-update structured document, said objective element corresponding to an objective element specified by a search formula in said structured document, based on the partial structures detected by said partial structure detection unit and said search formula; and
search formula update unit which updates said search formula using the structure information reconstituted by said structure reconstitution unit such that the objective element estimated by said objective element estimation unit is specified in said post-update structured document.

12. The search formula update device according to claim 11, further comprising:
structured document storage unit which accumulates said structured documents;
structure information analysis unit which analyzes said structure information from said structured documents accumulated;
search formula generation unit which generates said search formula such that said structure information is represented; and
said partial structure extraction unit extracting said partial structure from said structure information expressed by said search formula.

13. The search formula update device according to claim 11, wherein
structure information on said structured document is expressed by a tree structure including a set of elements; and wherein
said partial structure extraction unit extracts one of: one of a shortest path of each of said elements from a route element, a shortest path of each of said elements from said objective element, each end element, a route from each of said elements to an element connected by a number of steps set in advance and each element of a kind set in advance among each of said elements; and combinations thereof, respectively, as said partial structure.

14. The search formula update device according to claim 13, wherein,
when, among the partial structures detected by said partial structure detection unit from the post-update structured document, the partial structure not connected to any of the partial structures connected in a manner including a route element in said post-update structured document exists, about the not-connected partial structure, said structure reconstitution unit pursues a parent element until one of said route element and an element included in one of the partial structures connected in a manner including said route element is reached, and connects the not-connected partial structure to the reached element along with a pursued route.

15. The search formula update device according to claim 11, wherein
said objective element estimation unit estimates, among the partial structures detected from said post-update structured document, an element corresponding to, in the partial structure having included said objective element prior to update, said objective element as the objective element in said post-update structured document.

16. The search formula update device according to claim 15, wherein,
when a plurality of elements can be estimated as said objective element in said post-update structured document, said objective element estimation unit estimates, among said plurality of elements, the element included in a most larger number of said partial structures in said post-update structured document as said objective element.

17. The search formula update device according to claim 11, wherein
said structured document is an XML (Extensible Markup Language) document, and said search formula is XPath (XML Path Language) Formula.

18. A search formula update method, comprising the steps, carried out by
a search formula update device for updating a search formula for specifying an objective element of a structured document, of:
extracting part of partial structures from structure information on a structured document;
detecting, among said extracted partial structures, partial structures constituting a structure of a post-update structured document made by updating said structured document;
reconstituting structure information on said post-update structured document by connecting said detected partial structures;
estimating an objective element of said post-update structured document, said objective element corresponding to an objective element of said structured document, based on said detected partial structures and said search formula; and
updating said search formula, based on said reconstituted structure information and said estimated objective element, such that said objective element is specified in said post-update structured document.

19. The search formula update method according to claim 18, wherein
said search formula update device
accumulates said structured document in a storage device;
analyzes said structure information from said structured document accumulated in said storage device;
generates said search formula such that said structure information is represented; and,
said extracting partial structures extracts said partial structures from said structure information represented by said search formula.

20. The search formula update method according to claim 18, wherein
structure information on said structured document is expressed by a tree structure including a set of elements; and wherein
said search formula update device extracts one of: one of a shortest path of each of said elements from a route element, a shortest path of each of said elements from said objective element, each end element, a route from each of said elements to an element connected by a number of steps set in advance and each element of a kind set in advance among each of said elements; and combinations thereof, respectively, as said partial structure.

21. The search formula update method according to claim 20, wherein,
when, among the partial structures detected from said post-update structured document, the partial structure not connected to any of partial structures connected in a manner including a route element in said post-update structured document exists, about the not-connected partial structure, said search formula update device pursues a parent element until one of said route element and an element included in one of the partial structures connected in a manner including said route element is reached, and connects the not-connected partial structure to the reached element along with a pursued route.

22. The search formula update method according to claim 18, wherein
said search formula update device estimates, among the partial structures detected from said post-update structured document, an element corresponding to, in the partial structure having included said objective element prior to update, said objective element as the objective element in said post-update structured document.

23. The search formula update method according to claim 22, wherein,
when a plurality of elements can be estimated as said objective element in said post-update structured document, said search formula update device estimates, among said plurality of elements, the element included in a most larger number of said partial structures in said post-update structured document as said objective element.

24. The search formula update method according to claim 18, wherein
said structured document is an XML (Extensible Markup Language) document, and said search formula is XPath (XML Path Language) Formula.

25. A recording medium storing a search formula update program for causing a computer to execute:
processing of extracting part of partial structures from structure information on a structured document;
processing of detecting, among the partial structures extracted by said processing of extracting partial structures, partial structures constituting a structure of a post-update structured document made by updating said structured document;
processing of reconstituting structure information on said post-update structured document by connecting the partial structures detected by said processing of detecting partial structures constituting said structure;
processing of estimating an objective element of said post-update structured document, said objective element corresponding to an objective element of said structured document, based on said detected partial structures and said search formula; and
processing of updating said search formula, based on said reconstituted structure information and said objective element estimated by said processing of estimating an objective element, such that said objective element is specified in said post-update structured document.

26. The recording medium storing a search formula update program according to claim 25, further causing said computer to carry out:
processing of accumulating said structured document in a storage device;
processing of analyzing said structure information from said structured document accumulated in said storage device;
processing of generating said search formula such that said structure information is represented; and,
said processing of extracting partial structures is processing of extracting said partial structures from said structure information represented by said search formula.

27. The recording medium storing a search formula update program according to claim 25, wherein
structure information on said structured document is expressed by a tree structure including a set of elements; and wherein
said processing of extracting said partial structures is processing for extracting one of: one of a shortest path of each of said elements from a route element, a shortest path of each of said elements from said objective element, each end element, a route from each of said elements to an element connected by a number of steps set in advance and each element of a kind set in advance among each of said elements; and combinations thereof, respectively, as said partial structure.

28. The recording medium storing a search formula update program according to claim 27, wherein
said processing of reconstituting structure information is processing for, when, among the partial structures detected by said processing of extracting partial structures from the post-update structured document, the partial structure not connected to any of partial structures connected in a manner including a route element in said post-update structured document exists, about the not-connected partial structure, said search formula update device pursues a parent element until one of said route element and an element included in one of the partial structures connected in a manner including said route element is reached, and connects the not-connected partial structure to the reached element along with a pursued route.

29. The recording medium storing a search formula update program according to claims 25, wherein
said processing of estimating said objective element is processing of estimating, among the partial structures detected from said post-update structured document, an element corresponding to, in the partial structure having included said objective element prior to update, said objective element as the objective element in said post-update structured document.

30. The recording medium storing a search formula update program according to claim 29, wherein,
processing of estimating said objective element is processing of estimating, when a plurality of elements can be estimated as said objective element in said post-update structured document, among said plurality of elements, the element included in a most larger number of said partial structures in said post-update structured document as said objective element.
